(19) United States
(12) Patent Application Publication
(10) Pub. No.: US 2025/0136630 A1
(43) Pub. Date: May 1, 2025

(54) METHODS FOR PURIFYING BIS (ARENE) NICKEL COMPLEXES AND RELATED PRODUCTS

(71) Applicant: ENTEGRIS, INC., Billerica, MA (US)

(72) Inventor: Drew Michael Hood, Newtown, CT (US)

(21) Appl. No.: 18/930,920

(22) Filed: Oct. 29, 2024

Related U.S. Application Data
(60) Provisional application No. 63/546,515, filed on Oct. 30, 2023.
(60) Provisional application No. 63/546,518, filed on Oct. 30, 2023.

(51) Int. Cl. C07F 15/04

(52) U.S. Cl. CPC C07F 15/04

(57) ABSTRACT

Methods for purifying bis (arene) nickel complex products and related products are provided. A method comprises obtaining a crude mixture comprising a bis (arene) nickel complex and at least one impurity, dissolving the crude mixture in a recrystallization solvent so as to obtain a saturated solution of the crude mixture, recrystallizing the bis (arene) nickel complex, and removing the recrystallization solvent so as to obtain a purified bis (arene) nickel complex product.

### CROSS-REFERENCE TO RELATED APPLICATIONS

This application claims the benefit under 35 USC 119 of U.S. Provisional Patent Application Nos. 63/546,518, filed Oct. 30, 2023, and 63/546,515 filed on Oct. 30, 2023, the disclosure of each is hereby incorporated herein by reference in its entirety.

### FIELD

The present disclosure relates to methods of purifying bis (arene) nickel complexes and related products.

### BACKGROUND

Preparing high purity bis (arene) nickel complexes, for example, for use as nickel precursors, for preparing nickel silicates, as atomic layer deposition precursors, or other similar processes, remains an ongoing challenge.

### SUMMARY

Some embodiments of the present disclosure related to a method of purifying a bis (arene) nickel complex. In some embodiments, the method comprises obtaining a crude mixture comprising a bis (arene) nickel complex and at least one impurity; dissolving the crude mixture in a recrystallization solvent so as to obtain a saturated solution of the crude mixture, recrystallizing the bis (arene) nickel complex, and removing the recrystallization solvent so as to obtain a purified bis (arene) nickel complex product.

Some embodiments of the present disclosure relate to a bis (arene) nickel complex comprising a purity of 95% or greater. In some embodiments, the purified bis (arene) nickel complex is a recrystallized bis (arene) nickel complex product.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a flowchart of a method of purifying a bis (arene) nickel complex, according to some embodiments.

FIG. 2 is graph showing ¹H nuclear magnetic resonance (NMR) spectra of a bis (arene) nickel complex as received and a bis (arene) nickel complex purified according to some embodiments of the present disclosure.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “dissolve,” “dissolving,” “dissolved,” and grammatical equivalents thereof mean more than 95 wt % of the bis (arene) nickel complex present in the crude mixture is dissolved or otherwise solubilized, for example more than 97 wt %, more than 98 wt %, or more that 99 wt %.

For example, and without limitation, the present disclosure relates to methods of purifying bis (arene) nickel complexes and purified products obtained using methods of the present disclosure. Some embodiments further provide methods for purifying and/or removing impurities from crude mixtures and compositions comprising purified bis (arene) nickel complexes. Such purified bis (arene) nickel complexes are suitable for use as precursors for obtaining nickel silicate products, for use as atomic layer deposition precursors or other similar processes.

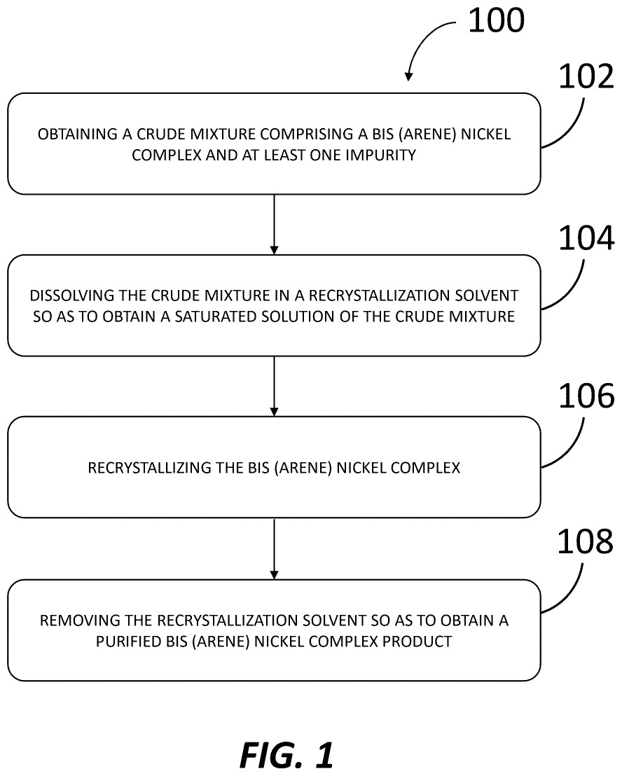

FIG. 1 depicts a schematic representation of a method according to some embodiments. In some embodiments, the method 100 for purifying a bis (arene) nickel complex may comprise one or more of the following steps: a step 102 of obtaining a crude mixture comprising a bis (arene) nickel complex and at least one impurity, a step 104 of dissolving the crude mixture in a recrystallization solvent so as to obtain a saturated solution of the crude mixture, a step 106 of recrystallizing the bis (arene) nickel complex, and a step 108 of removing the recrystallization solvent so as to obtain a purified bis (arene) nickel complex product.

At step 102, in some embodiments, the crude mixture comprises a solid reagent. In some embodiments, the solid reagent comprises at least one of a bis (arene) nickel complex. In some embodiments, the solid reagent comprises a nickelocene compound. In some embodiments, the bis (arene) nickel complex comprises a bis (cyclopentadiene) nickel (Cp₂Ni) complex. In some embodiments, the bis (arene) nickel complex comprises a bis (benzene) nickel complex, a bis (toluene) nickel complex, a bis (xylene) nickel complex, a bis (butyltoluene) nickel complex, a bis (ethyl methyl benzene) nickel complex, a bis (ethyl methylbenzene) nickel complex, a bis (isopropyl methyl benzene) nickel complex, a bis (butyl methylbenzene) nickel complex, a bis (mesitylene) nickel complex, a bis (pseudocumene) nickel complex, a bis (durene) nickel complex, a bis (methylbenzene) nickel complex, a bis (dimethylbenzene) nickel complex, a bis (trimethylbenzene) nickel complex, a bis (ethylbenzene) nickel complex, a bis (1,4-diethylbenzene) nickel complex, a bis (triethylbenzene) nickel complex, a bis (propylbenzene) nickel complex, a bis (butylbenzene) nickel complex, a bis (iso-butylbenzene) nickel complex, a bis (sec-butylbenzene) nickel complex, a bis (t-butylbenzene) nickel complex, a bis (hexylbenzene) nickel complex, a bis (styrene) metal complex, a bis (naphthalene) nickel complex, a bis (anthracene) nickel complex, a bis (phenanthrene) nickel complex, a bis (biphenyl) nickel complex, a bis (terphenyl) nickel complex, a bis (methylnaphthalene) nickel complex, a bis (biphenylene) nickel complex, a bis (dimethylnaphthalene) nickel complex, a bis (methylanthracene) nickel complex, a bis (4,4′-dimethylbiphenyl) nickel complex, a bis (bibenzyl) nickel complex, a bis (diphenylmethane) nickel complex, a bis (indene) nickel complex, a bis (fluorene) nickel complex, any isomer thereof, or any combination thereof. In some embodiments, the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, any isomer thereof, or any combination thereof.

In some embodiments, the crude mixture comprises at least one impurity. In some embodiments, the crude mixture comprises 2% to 9% by weight of at least one impurity based on a total weight of the crude mixture, or any range or subrange between 2% and 9%. For example, in some embodiments, the mixture comprises 2% to 8%, 2% to 7%, 2% to 6%, 2% to 5%, 2% to 4%, 2% to 3%, 3% to 9%, 4% to 9%, 5% to 9%, 6% to 9%, 7% to 9%, or 8% to 9% by weight of at least one impurity based on a total weight of the crude mixture. In some embodiments, the at least one impurity is present in the crude mixture in an amount of at least 8.5%, 8.4%, 8.2%, 8%, 7.5%, 7%, 6.5%, 6%, 5.5%, 5%, 4.5%, 4%, 3.5%, 3%, 2.5%, or 2% by weight of the at least one impurity based on a total weight of the crude mixture. In some embodiments, the at least one impurity is detectable by nuclear magnetic resonance (NMR) spectroscopic analysis.

At step 104, in some embodiments, the recrystallization solvent comprises toluene, ethers, alkanes, aromatics, dichloromethane, acetonitrile, or any combinations thereof. In some embodiments, the recrystallization solvent comprises toluene. In some embodiments, the recrystallization solvent comprises ethers. In some embodiments, the recrystallization solvent comprises alkanes. In some embodiments, the recrystallization solvent comprises aromatics. In some embodiments, the recrystallization solvent comprises dichloromethane. In some embodiments, the recrystallization solvent comprises acetonitrile. In some embodiments, the ethers comprise diethyl ether, tetrahydrofuran, diisopropyl ether, 1-methyl-tetrahydrofuran, dibutyl ether, methyl tert-butyl ether, dioxane, dimethoxyethane, or any combinations thereof. In some embodiments, the ethers comprise diethyl ether. In some embodiments, the ethers comprise tetrahydrofuran. In some embodiments, the ethers comprise diisopropyl ether. In some embodiments, the ethers comprise 1-methyl-tetrahydrofuran. In some embodiments, the ethers comprise dibutyl ether. In some embodiments, the ethers comprise methyl tert-butyl ether. In some embodiments, the ethers comprise dioxane. In some embodiments, the ethers comprise dimethoxyethane. In some embodiments, the alkanes comprise pentane, hexane, heptane, nonane, octane, decane, undecane, dodecane, any isomers thereof, or any combinations thereof. In some embodiments, the alkanes comprise pentane. In some embodiments, the alkanes comprise hexane. In some embodiments, the alkanes comprise heptane. In some embodiments, the alkanes comprise nonane. In some embodiments, the alkanes comprise octane. In some embodiments, the alkanes comprise decane. In some embodiments, the alkanes comprise undecane. In some embodiments, the alkanes comprise dodecane. In some embodiments, the aromatics comprise benzene, toluene, ethylbenzene, benzyl alcohol, xylene, mixed xylenes, or any combinations thereof. In some embodiments, the aromatics comprise benzene. In some embodiments, the aromatics comprise toluene. In some embodiments, the aromatics comprise ethylbenzene. In some embodiments, the aromatics comprise benzyl alcohol. In some embodiments, the aromatics comprise xylene. In some embodiments, the aromatics comprise mixed xylenes.

In some embodiments, the dissolving comprises contacting the crude mixture and the recrystallization solvent. In some embodiments, the contacting comprises bringing into immediate or close proximity, or into direct physical contact. In some embodiments, the dissolving comprises contacting the crude mixture and the recrystallization solvent under heating. In some embodiments, the recrystallization solvent is heated to dissolve additional crude mixture in the recrystallization solvent. In some embodiments, the recrystallization solvent is heated to obtain a supersaturated solution of the crude mixture. In some embodiments, the heating comprises heating the saturated solution of the crude mixture in a first vessel to a first temperature. The first vessel may be configured to control temperature. The temperature of the first vessel may be controlled in any suitable manner. In some embodiments, a thermal jacket for heating is employed around the first vessel. In some embodiments, a ribbon heater is wound around the first vessel. In some embodiments, a block heater having a shape covering at least a major portion of the external surface of the first vessel is employed to heat the first vessel. In some embodiments, a resistive heater is employed to heat the first vessel. In some embodiments, a lamp heater is employed to heat the first vessel. In some embodiments, a heat transfer fluid at elevated temperature may be contacted with the exterior surface of the first vessel, to effect heating and/or cooling thereof. In some embodiments, the heating is conducted by infrared or other radiant energy being impinged on the first vessel. It is to be appreciated that other heating devices and assemblies, and other configurations and arrangements of the heater may be employed herein without departing from the scope of this disclosure.

In some embodiments, the first temperature is a temperature of 50° C. to 200° C., or any range or subrange between 50° C. and 200° C. In some embodiments, the first temperature is a temperature in a range of 60° C. to 200° C., 70° C. to 200° C., 80° C. to 200° C., 90° C. to 200° C., 100° C. to 200° C., 110° C. to 200° C., 120° C. to 200° C., 130° C. to 200° C., 140° C. to 200° C., 150° C. to 200° C., 160° C. to 200° C., 170° C. to 200° C., 180° C. to 200° C., or 190° C. to 200° C. In some embodiments, the first temperature is a temperature in a range of 50° C. to 190° C., 50° C. to 180° C., 50° C. to 170° C., 50° C. to 160° C., 50° C. to 150° C., 50° C. to 140° C., 50° C. to 130° C., 50° C. to 120° C., 50° C. to 110° C., 50° C. to 100° C., 50° C. to 90° C., 50° C. to 80° C., 50° C. to 70° C., or 50° C. to 60° C. In some embodiments, the first temperature is a temperature of 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175,° C., 180° C., 185° C., 190° C., 195° C., or 200° C.

In some embodiments, the solution of the crude mixture is seeded with a bis (arene) nickel crystal seed. In some embodiments, the saturated solution of the crude mixture is seeded with a bis (arene) nickel crystal seed. In some embodiments, the supersaturated solution of the crude mixture is seeded with a bis (arene) nickel crystal seed.

At step 106, in some embodiments, the method comprises recrystallizing the bis (arene) nickel complex. In some embodiments, the recrystallizing comprises allowing the saturated solution of the crude mixture to cool to a second temperature sufficient for the bis (arene) nickel complex to recrystallize. In some embodiments, the recrystallizing comprises cooling the saturated solution of the crude mixture to a second temperature sufficient for the bis (arene) nickel complex to recrystallize. In some embodiments, the recrystallizing comprises using a cold bath (e.g., an ice water bath) to cool the saturated solution of the crude mixture to a second temperature sufficient for the bis (arene) nickel complex to recrystallize. In some embodiments, the recrystallizing comprises using a cooling jacket to cool the saturated solution of the crude mixture to a second temperature sufficient for the bis (arene) nickel complex to recrystallize. It will be appreciated that other techniques for cooling may be employed herein without departing from the scope of this disclosure.

In some embodiments, the second temperature is a temperature of −30° C. to 50° C., or any range or subrange between −30° C. and 50° C. In some embodiments, the second temperature is a temperature in a range of −30° C. to 40° C., −30° C. to 30° C., −30° C. to 20° C., −30° C. to 10° C., −30° C. to 0° C., −30° C. to −10° C., or −30° C. to −20° C. In some embodiments, the second temperature is a temperature in a range of −20° C. to 50° C., −10° C. to 50° C., 0° C. to 50° C., 10° C. to 50° C., 20° C. to 50° C., 30° C. to 50° C., or 40° C. to 50° C. In some embodiments, the second temperature is a temperature of −30° C., −25° C., −20° C., −15° C., −10° C., −5° C., 0° C., 5° C., 10° C., 15° C., 20° C., 25° C., 30° C., 35° C., 40° C., 45° C., or 50° C.

At step 108, in some embodiments, method further comprises removing the recrystallization solvent so as to obtain a purified bis (arene) nickel complex product. In some embodiments, the removing comprises filtering the recrystallization solvent comprising the recrystallized bis (arene) nickel complex product. In some embodiments, the removing comprises separating the recrystallization solvent comprising the recrystallized bis (arene) nickel complex product.

In some embodiments, the filtering comprises flowing the recrystallization solvent comprising the recrystallized bis (arene) nickel complex product over a fritted filter.

In some embodiments, the flowing comprises delivering the recrystallization solvent comprising the recrystallized bis (arene) nickel complex product over the fritted filter. In some embodiments, the flowing comprises discharging the recrystallization solvent comprising the recrystallized bis (arene) nickel complex product over the fritted filter. In some embodiments, the flowing comprises feeding the recrystallization solvent comprising the recrystallized bis (arene) nickel complex product over the fritted filter. In some embodiments, the flowing comprises passing the recrystallization solvent comprising the recrystallized bis (arene) nickel complex product over the fritted filter. In some embodiments, the flowing comprises pumping the recrystallization solvent comprising the recrystallized bis (arene) nickel complex product over the fritted filter. In some embodiments, the flowing comprises supplying the recrystallization solvent comprising the recrystallized bis (arene) nickel complex product over the fritted filter. It will be appreciated that the manner in which the recrystallization solvent comprising the recrystallized bis (arene) nickel complex product is provided over the fritted filter is not particularly limited and may include any suitable technique known in the art.

For example, in some embodiments, a cannula is employed for the removing the recrystallization solvent. In some embodiments, the removing comprises decanting the recrystallization solvent to obtain the purified recrystallized bis (arene) nickel complex. In some embodiments, the removing comprises pipetting the recrystallization solvent to obtain the purified recrystallized bis (arene) nickel complex. In some embodiments, the removing comprises pouring the recrystallization solvent out to obtain the purified recrystallized bis (arene) nickel complex. In some embodiments, the removing comprises transferring the recrystallization solvent to another reaction vessel to obtain the purified recrystallized bis (arene) nickel complex.

Some embodiments relate to a purified bis (arene) nickel complex. In some embodiments, the purified bis (arene) nickel complex is obtained by recrystallization.

In some embodiments, a purity of the bis (arene) nickel complex (e.g., bis (cyclopentadiene) nickel) is 95% to 99.9999%, or any range or subrange between 95% to 99.9999%. For example, in some embodiments, the purity of the bis (arene) nickel complex is 96% to 99.9999%, 97% to 99.9999%, 98% to 99.9999%, 99% to 99.9999%, 95% to 99.9%, 95% to 99,99%, or 95% to 99.999%. In some embodiments, the bis (arene) nickel complex comprises a purity of 95% or greater. In some embodiments, the bis (arene) nickel complex comprises a purity of 95% or greater when purified by recrystallization. In some embodiments, the bis (arene) nickel complex comprises a purity of 98% or greater. In some embodiments, the bis (arene) nickel complex comprises a purity of 98% or greater when purified by recrystallization.

In some embodiments, the purified recrystallized bis (arene) nickel complex product comprises less than 1.3% by weight of at least one impurity based on a total weight of the purified bis (arene) nickel complex product. For example, in some embodiments, the purified recrystallized bis (arene) nickel complex product comprises less than: 1.2%, 1.1%, 1.0%, 0.9%, 0.8%, 0.7%, 0.6%, 0.5%, 0.4%, 0.3%, 0.2%, or 0.1% by weight of at least one impurity based on a total weight of the purified recrystallized bis (arene) nickel complex product.

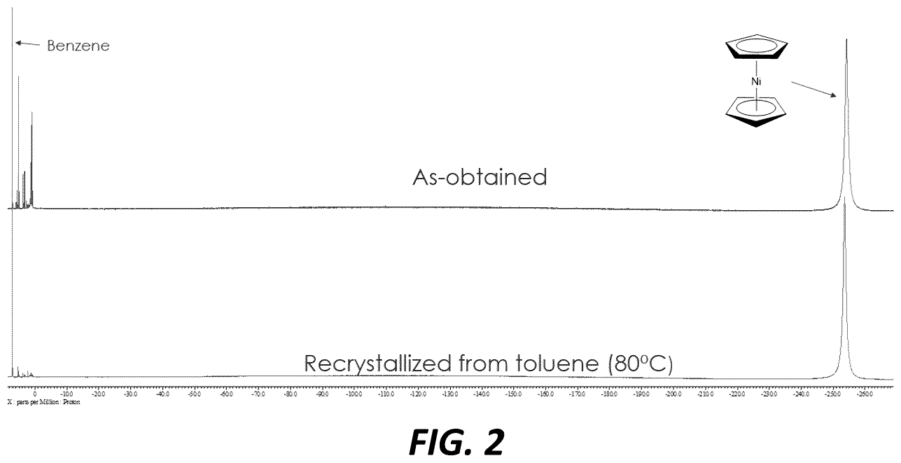

As shown in FIG. 2, purified bis (cyclopentadiene) nickel complex shows an improved profile when analyzed by nuclear magnetic resonance (NMR).

In some embodiments, the purified bis (arene) nickel complex product is stable over 32 days at a temperature of 75° C.

### Aspects

Various Aspects are described below. It is to be understood that any one or more of the features recited in the following Aspect(s) can be combined with any one or more other Aspect(s).

Aspect 1. A method comprising:
obtaining a crude mixture comprising a bis (arene) nickel complex and at least one impurity;
dissolving the crude mixture in a recrystallization solvent so as to obtain a saturated solution of the crude mixture;
recrystallizing the bis (arene) nickel complex; and
removing the recrystallization solvent so as to obtain a purified bis (arene) nickel complex product.

Aspect 2. The method according to Aspect 1, further comprising heating the recrystallization solvent so as to obtain a supersaturated solution of the crude mixture.

Aspect 3. The method according to any one of Aspects 1-2, wherein the recrystallization solvent is heated to about 80° C.

Aspect 4. The method according to any one of Aspects 1-3, further comprising seeding the solution of saturated solution of the crude mixture.

Aspect 5. The method according to any one of Aspects 1-4, wherein the recrystallization solvent is cooled to about −30° C.

Aspect 6. The method according to any one of Aspects 1-5, wherein removing the recrystallization solvent comprises filtration.

Aspect 7. The method according to any one of Aspects 1-6, wherein the purified bis (arene) nickel complex product has less than 0.8% of the at least one impurity.

Aspect 8. The method according to any one of Aspects 1-7, wherein the at least one impurity is detectable by nuclear magnetic resonance (NMR) spectroscopic analysis.

Aspect 9. The method according to any one of Aspects 1-8, wherein the purified bis (arene) nickel complex product is stable over 32 days at a temperature of 75° C.

Aspect 10. The method according to any one of Aspects 1-9, wherein the recrystallization solvent comprises toluene, ethers, alkanes, aromatics, dichloromethane, acetonitrile, or any combinations thereof.

Aspect 11. The method according to Aspect 10, wherein the ethers comprise diethyl ether, tetrahydrofuran, diisopropyl ether, 1-methyl-tetrahydrofuran, dibutyl ether, methyl tert-butyl ether, dioxane, dimethoxyethane, or any combinations thereof.

Aspect 12. The method according to Aspect 10, wherein the alkanes comprise pentane, hexane, heptane, nonane, octane, decane, undecane, dodecane, any isomers thereof, or any combinations thereof.

Aspect 13. The method according to Aspect 10, wherein the aromatics comprise benzene, toluene, ethylbenzene, benzyl alcohol, xylene, mixed xylenes, or any combinations thereof.

Aspect 14. The method according to any one of Aspects 1-13, wherein the bis (arene) nickel complex comprises a bis (cyclopentadienyl) nickel complex, a bis (benzene) nickel complex, a bis (toluene) nickel complex, a bis (xylene) nickel complex, a bis (butyltoluene) nickel complex, a bis (ethyl methyl benzene) nickel complex, a bis (ethyl methylbenzene) nickel complex, a bis (isopropyl methyl benzene) nickel complex, a bis (butyl methylbenzene) nickel complex, a bis (mesitylene) nickel complex, a bis (pseudocumene) nickel complex, a bis (durene) nickel complex, a bis (methylbenzene) nickel complex, a bis (dimethylbenzene) nickel complex, a bis (trimethylbenzene) nickel complex, a bis (ethylbenzene) nickel complex, a bis (1,4-diethylbenzene) nickel complex, a bis (triethylbenzene) nickel complex, a bis (propylbenzene) nickel complex, a bis (butylbenzene) nickel complex, a bis (iso-butylbenzene) nickel complex, a bis (sec-butylbenzene) nickel complex, a bis (t-butylbenzene) nickel complex, a bis (hexylbenzene) nickel complex, a bis (styrene) metal complex, a bis (naphthalene) nickel complex, a bis (anthracene) nickel complex, a bis (phenanthrene) nickel complex, a bis (biphenyl) nickel complex, a bis (terphenyl) nickel complex, a bis (methylnaphthalene) nickel complex, a bis (biphenylene) nickel complex, a bis (dimethylnaphthalene) nickel complex, a bis (methylanthracene) nickel complex, a bis (4,4′-dimethylbiphenyl) nickel complex, a bis (bibenzyl) nickel complex, a bis (diphenylmethane) nickel complex, a bis (indene) nickel complex, a bis (fluorene) nickel complex, or any isomer thereof.

Aspect 15. The method according to any one of Aspects 1-14, wherein the bis (arene) nickel complex comprises bis (cyclopentadiene) nickel.

Aspect 16. The method according to any one of Aspect 1-15, wherein the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, or any isomer thereof.

Aspect 17. A bis (arene) nickel complex, comprising a purity of 95% or greater, wherein the bis (arene) nickel complex is a recrystallized bis (arene) nickel complex product.

Aspect 18. The bis (arene) nickel complex according to Aspect 17, wherein the purity is 99% or greater.

Aspect 19. The bis (arene) nickel complex according to any one of Aspects 17-18, comprising at least one impurity of 0.8% or less.

Aspect 20. The bis (arene) nickel complex according to Aspect 19, wherein the at least one impurity is detectable by nuclear magnetic resonance (NMR) spectroscopic analysis.

Aspect 21. The bis (arene) nickel complex according to any one of Aspects 17-20, wherein the bis (arene) nickel complex comprises bis (cyclopentadiene) nickel.

Aspect 22. The method according to any one of Aspects 17-19, wherein the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, or any isomer thereof.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
obtaining a crude mixture comprising a bis (arene) nickel complex and at least one impurity;
dissolving the crude mixture in a recrystallization solvent so as to obtain a saturated solution of the crude mixture;
recrystallizing the bis (arene) nickel complex; and
removing the recrystallization solvent so as to obtain a purified bis (arene) nickel complex product.

2. The method of claim 1, further comprising heating the recrystallization solvent so as to obtain a supersaturated solution of the crude mixture.

3. The method of claim 1, wherein the recrystallization solvent is heated to about 80° C.

4. The method of claim 1, wherein the recrystallization solvent is cooled to about −30° C.

5. The method of claim 1, further comprising seeding the saturated solution of the crude mixture.

6. The method of claim 1, wherein removing the recrystallization solvent comprises filtration.

7. The method of claim 1, wherein the purified bis (arene) nickel complex product has less than 0.8% of the at least one impurity.

8. The method of claim 1, wherein the at least one impurity is detectable by nuclear magnetic resonance (NMR) spectroscopic analysis.

9. The method of claim 1, wherein the purified bis (arene) nickel complex product is stable over 32 days at a temperature of 75° C.

10. The method of claim 1, wherein the recrystallization solvent comprises toluene, ethers, alkanes, aromatics, dichloromethane, acetonitrile, or any combinations thereof.

11. The method of claim 10, wherein the ethers comprise diethyl ether, tetrahydrofuran, diisopropyl ether, 1-methyl-tetrahydrofuran, dibutyl ether, methyl tert-butyl ether, dioxane, dimethoxyethane, or any combinations thereof.

12. The method of claim 10, wherein the alkanes comprise pentane, hexane, heptane, nonane, octane, decane, undecane, dodecane, any isomers thereof, or any combinations thereof.

13. The method of claim 10, wherein the aromatics comprise benzene, toluene, ethylbenzene, benzyl alcohol, xylene, mixed xylenes, or any combinations thereof.

14. The method of claim 1, wherein the bis (arene) nickel complex comprises a bis (cyclopentadienyl) nickel complex, a bis (benzene) nickel complex, a bis (toluene) nickel complex, a bis (xylene) nickel complex, a bis (butyltoluene) nickel complex, a bis (ethyl methyl benzene) nickel complex, a bis (ethyl methylbenzene) nickel complex, a bis (isopropyl methyl benzene) nickel complex, a bis (butyl methylbenzene) nickel complex, a bis (mesitylene) nickel complex, a bis (pseudocumene) nickel complex, a bis (durene) nickel complex, a bis (methylbenzene) nickel complex, a bis (dimethylbenzene) nickel complex, a bis (trimethylbenzene) nickel complex, a bis (ethylbenzene) nickel complex, a bis (1,4-diethylbenzene) nickel complex, a bis (triethylbenzene) nickel complex, a bis (propylbenzene) nickel complex, a bis (butylbenzene) nickel complex, a bis (iso-butylbenzene) nickel complex, a bis (sec-butylbenzene) nickel complex, a bis (t-butylbenzene) nickel complex, a bis (hexylbenzene) nickel complex, a bis (styrene) metal complex, a bis (naphthalene) nickel complex, a bis (anthracene) nickel complex, a bis (phenanthrene) nickel complex, a bis (biphenyl) nickel complex, a bis (terphenyl) nickel complex, a bis (methylnaphthalene) nickel complex, a bis (biphenylene) nickel complex, a bis (dimethylnaphthalene) nickel complex, a bis (methylanthracene) nickel complex, a bis (4,4′-dimethylbiphenyl) nickel complex, a bis (bibenzyl) nickel complex, a bis (diphenylmethane) nickel complex, a bis (indene) nickel complex, a bis (fluorene) nickel complex, or any isomer thereof.

15. The method of claim 1, wherein the bis (arene) nickel complex comprises bis (cyclopentadiene) nickel.

16. The method of claim 1, wherein the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, any isomer thereof, or any combination thereof.

17. A bis (arene) nickel complex, comprising a purity of 95% or greater, wherein the bis (arene) nickel complex is a recrystallized bis (arene) nickel complex product.

18. The bis (arene) nickel complex of claim 17, wherein the purity is 99% or greater.

19. The bis (arene) nickel complex of claim 17, comprising at least one impurity of 0.8% or less.

20. The bis (arene) nickel complex of claim 19, wherein the at least one impurity is detectable by nuclear magnetic resonance (NMR) spectroscopic analysis.

21. The bis (arene) nickel complex of claim 17, wherein the bis (arene) nickel complex comprises bis (cyclopentadiene) nickel.

22. The bis (arene) nickel complex of claim 17, wherein the bis (arene) nickel complex comprises bis (alkylcyclopentadiene) nickel, bis (methylcyclopentadiene) nickel, bis (ethylcyclopentadiene) nickel, bis (isopropylcyclopentadiene) nickel, bis (tert-butylcyclopentadiene) nickel, bis (pentamethylcyclopentadiene) nickel, any isomer thereof, or any combination thereof.
